(19) United States
(12) Patent Application Publication
(10) Pub. No.: US 2002/0077236 A1
(43) Pub. Date: Jun. 20, 2002

(54) Article aligning apparatus and method therefor

(76) Inventors: Eric Chalendar, Velles (FR); Francis Bennevault, Chateauroux (FR); Benoit Poutot, Chateauroux (FR)

Correspondence Address: Michael V. Drew, The Mead Corporation, Legal Department, 4850D North Church Lane, Smyrna, GA, 30080, US

(21) Appl. No.: 10/026,328

(22) Filed: Dec. 19, 2001

Related U.S. Application Data
(63) Continuation of application No. PCT/US00/17781, filed on Jun. 28, 2000.

(30) Foreign Application Priority Data
Jun. 28, 1999 (GB) 9915080.7
Oct. 25, 1999 (GB) 9925141.5

(51) Int. Cl. B31B 49/00

(52) U.S. Cl. 493/19

(57) ABSTRACT

An apparatus and a method therefor for continuously positioning an article, for example a carton blank delivered from one feed stream relative to a second article, for example an insert blank delivered from a second feed stream comprising one or more sensors to detect the respective positions of the first and second portions upstream of where the streams converge, correction means to correct the position of the second article relative to the first article, and a controller to determine the amount of adjustment required and to control the correction means accordingly.

### CROSS-REFERENCE TO RELATED APPLICATIONS

This is a continuation of international application No. PCT/US00/17781, filed Jun. 28, 2000, which is pending at the time of filing hereof, and which international application claims priority based upon GB patent application serial number 9915080.7, filed Jun. 28, 1999, and GB patent application serial number 9925141.5, filed Oct. 25, 1999.

### STATEMENT REGARDING FEDERALLY-SPONSORED RESEARCH AND DEVELOPMENT

(Not applicable)

### TECHNICAL FIELD OF THE INVENTION

The present invention relates to an apparatus and method for accurately aligning two articles. More particularly, the invention relates to apparatus and method for accurately aligning a carton blank from one feed stream with one or more inserts from a second feed stream as they progress down a carton forming machine, such that when the streams converge, the insert is placed in the correct location on the blank.

### BACKGROUND OF THE INVENTION

Inserts commonly constitute parts of relatively complex cartons, such as basket carriers, where they may, for example, be employed to form article dividers once the blank is formed into a carton. It is important that such inserts are accurately placed on the blank so that glue, which may have been applied to the blank, adheres to the correct portions of the insert(s), and so that once the carton has been formed, the insert(s) are in the correct location.

Known devices for aligning two articles, for example a carton blank and a group of bottles, generally comprise separate chain sets for the blank and the bottle grouping with synchronised lugs to engage the blank/bottle and feed them to a single convergence point thereby causing the bottle(s) to be aligned with the blank. One disadvantage of chain and lug feeds is that the pitch of the feed is fixed and therefore the lugs often must often be adjusted for changeovers between differing carton types, which increases machine downtime and therefore increases the unit cost of production for the end-user, if frequent changeovers are required.

For example, WO 93/08979 discloses an alignment apparatus where the two streams of articles are mechanically synchronised.

As an alternative to providing separate inserts in basket cartons or other carton types, a one piece blank can be used, which does not require a separate insert. These blanks usually require more paperboard than is used for a two piece blank, and furthermore require more folding operations to erect the carton. Again, this increases the unit cost of production. Furthermore, the one piece blank must use a single grade of paperboard, whereas with two piece blanks, it is possible to use different caliper paperboard for one or the other of the blanks, thereby to save materials costs.

This application also relates to the provision of nick breaking apparatus in a packaging machine. Such apparatus are well known for continuous strips of material. For example in U.S. Pat. No. 5,855,969 illustrates a nick apparatus for a continuous strip 48 is advanced or slowed down for a breakoff bar 72 by control apparatus which controls the movement of the strip.

### BRIEF SUMMARY OF THE INVENTION

The present invention seeks to overcome, or at least mitigate the problems of the prior art.

One aspect of the invention provides an apparatus for breaking the nicks of an article, for example a carton blank on a conveyor comprising nick breaking means, one or more sensors to detect the position of the article on the conveyor, alignment means to align the nick breaking means and the article, and a controller to determine the amount of adjustment required and to control the alignment means.

A second aspect of the invention provides an apparatus for continuously positioning an article, for example a carton blank delivered from one feed stream relative to a second article, for example an insert blank delivered from a second feed stream comprising one or more sensors to detect the respective positions of the first and second portions upstream of where the streams converge, correction means to correct the position of the second article relative to the first article, and a controller to determine the amount of adjustment required and to control the correction means accordingly. Preferably, the first and second feed streams may comprise first and second conveyor means.

According to an optional feature of the second aspect of the invention the first and second articles may be fed from continuous friction feeders from a storage hopper.

According to another optional feature of the second aspect of the invention the correction means may comprise an article correction belt driven independently of said second conveyor means. Preferably, the article correction belt may comprise upper and lower belts arranged so as to hold the second article therebetween.

According to another optional feature of the second aspect of the invention the article correction belt may be driven by a servo-motor.

According to another optional feature of the second aspect of the invention a plurality of article correction belts may be provided in series.

According to another optional feature of the second aspect of the invention the correction belt may feed onto a third conveyor means operating at the same speed as the first conveyor means.

According to a further optional feature of the second aspect of the invention the controller may determine the position of a second article, selects a first article in closest relative alignment thereto, and adjusts the speed of the correction means such that when the second article is engaged by a third conveyor means it is substantially in synchronism with the first article.

A third aspect of the invention provides a method of continuously positioning an article delivered from a first feed stream relative to a second article delivered from a second feed stream comprising the steps of determining the position and speed of continuous flow of first articles as they progress downstream; selecting one of the first articles in closest relative alignment to the second article, adjusting the linear position of the second article relative to the selected first article, and feeding the first and second articles downstream to a position where they converge in alignment. Preferably, a belt driven by a servo-motor may adjust the linear position of the second article.

A fourth aspect of the invention provides a controller for apparatus for continuously positioning a first article delivered from a first feed stream relative to a second article delivered from a second feed stream, wherein the controller processes information supplied from a first sensor which detects the position of a continuous stream of the first articles, and a second sensor which detects the position of the second articles, selects the first in closest relative alignment with the second article, determines the correction necessary to bring the first and second articles into the desired relative positions, and outputs an appropriate signal to a correction means for the necessary correction to be achieved.

Preferably, the controller may further control a mechanism for ejecting misaligned first and second articles.

According to an optional feature of the fourth aspect of the invention the controller may control apparatus for breaking the nicks of the first and for second articles comprising processing information of the position of the first and/or second articles, determine the position of nick breaking means relative said article and adjusting the nick breaking means to cause it to be aligned with said article.

A fifth aspect of the invention provides a control means for an apparatus for positioning articles of the first aspect of the invention, the control means comprising a central controller, a manual input means, and separate means controlled by said central controller for individually controlling the or each set of article correction belts.

According to an optional feature of the fifth aspect, the separate control means comprises a sensor and a processor for determining the position of the second article relative the first article.

Preferably, the first conveyor means is controlled by the central controller. More preferably, the speeds of the first and second article feeds are controlled by the central controller.

Optionally, the instruction to changeover from on article type to another is read from a pre-entered control program. Preferably, the speed of supply of articles is alterable as required depending on the size or type of the articles in each of said hoppers.

According to another optional feature of the fifth aspect of the invention, the relative positions and state of motion of each of the movable components is sensed using individual sensors and transmitted to the control means.

### BRIEF DESCRIPTION OF THE SEVERAL VIEWS OF THE DRAWINGS

Exemplary embodiments are now described by way of example only, with reference to the accompanying drawings, in which:

FIGS. 1 A to 1C show an example of a carton blank and inserts through the various stages of assembly in the apparatus according to one embodiment of the invention;

FIG. 2 is a schematic flow diagram of the blanks and inserts in the apparatus shown in FIG. 3;

FIG. 3 is a perspective view of the apparatus according to one embodiment of the present invention;

FIG. 4 is a close-up view of part of the apparatus of FIG. 3;

FIG. 5 is a perspective view of the nick breaker of the apparatus;

FIG. 6 is a schematic block diagram of apparatus for use in controlling an approximate correction device in the apparatus of FIG. 3;

FIG. 7 is a schematic block diagram of apparatus for use in controlling a precise correction device in the apparatus of FIG. 3; and

FIG. 8 is a schematic block diagram of apparatus for use in controlling an ejection mechanism in the apparatus of FIG. 3.

### DETAILED DESCRIPTION OF THE INVENTION

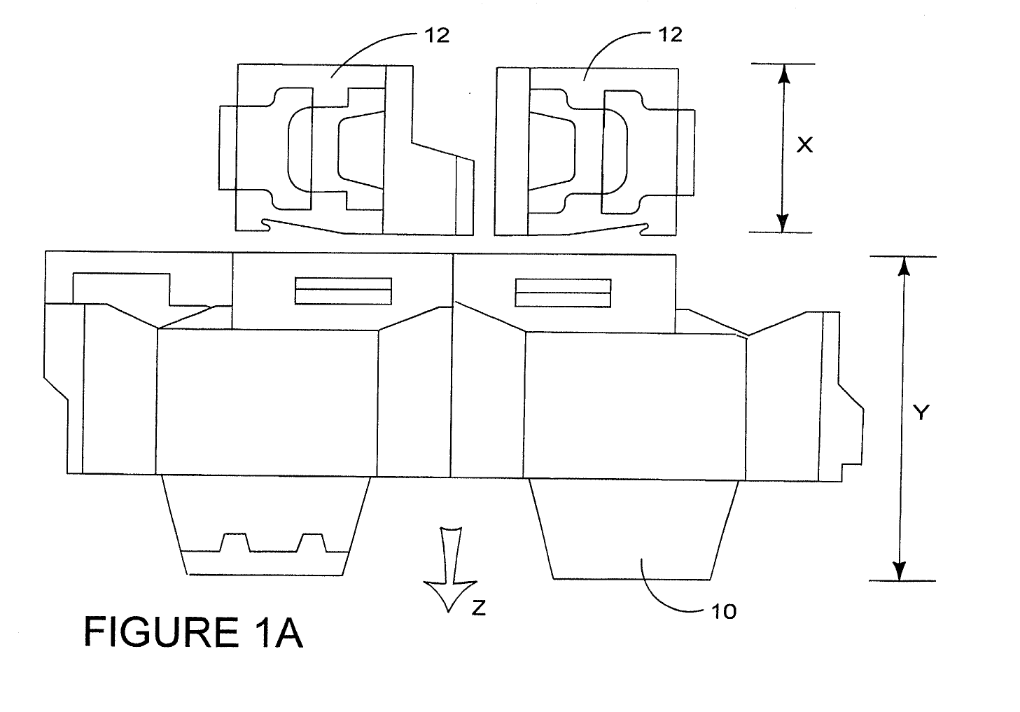

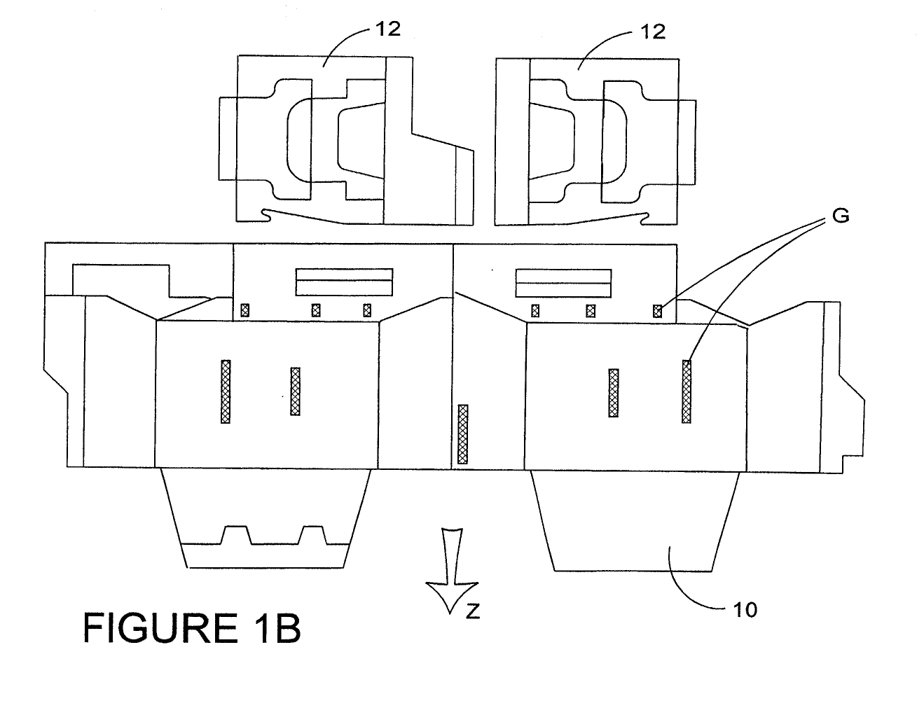

Referring to FIG. 1A, there is shown an example of two articles constructed from paperboard or similar foldable sheet material. In this embodiment, the articles are a carton blank 10 and pair of inserts 12 which may be used in the apparatus 16 of the present invention as would be seen at position A of FIG. 3. It is envisaged that there could be one or more than two inserts used in the apparatus of the present invention.

It will be seen that the blank 10, which in this embodiment is a basket-carrier, has a length Y in the direction of feed Z through the apparatus 16. The inserts 12 are required to be accurately glued onto the blank 10 to form a complete carton blank which may then be erected to accommodate a plurality of bottles or similar articles. The inserts 12 have a length X in their direction of feed Z through the apparatus 16. In this embodiment, the length X is significantly shorter than the length Y of the carton blank 10. Of course in other embodiments, the insert(s) 12 may be the same size or longer than the blank 10, without departing from the scope of invention.

The carton blank and the or each insert are aligned by the apparatus of one aspect of the invention and are thereafter secured together. FIG. 1B illustrates the preferred glue positions G of the carton blank 10 and the inserts 12. FIG. 1C shows the relative positions of the carton blank 10 and the inserts 12 at position C in FIG. 3. Once the blank and insert are secured together, they can be folded into a carton to receive articles in a packaging machine.

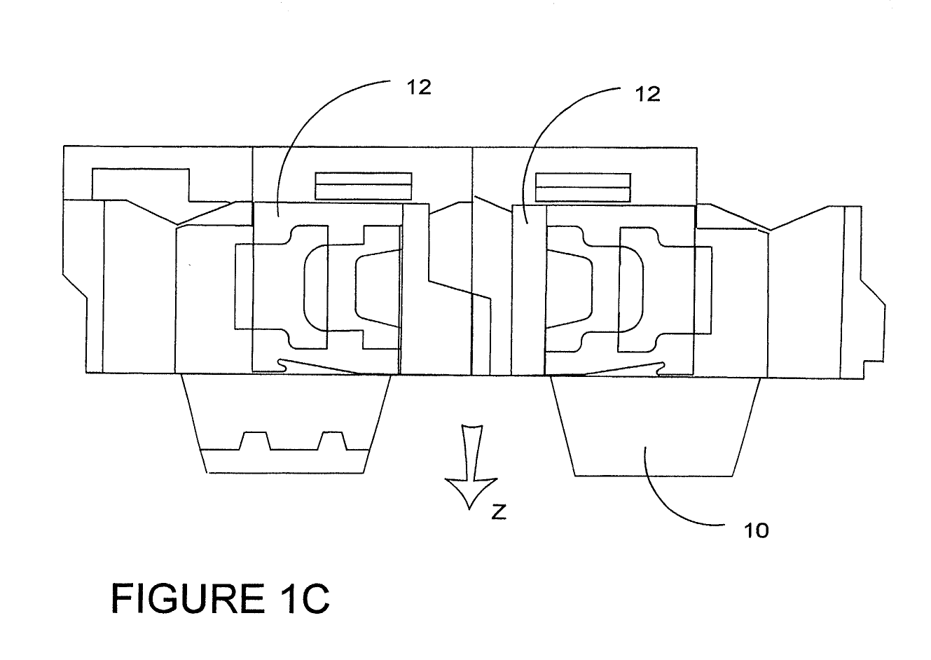

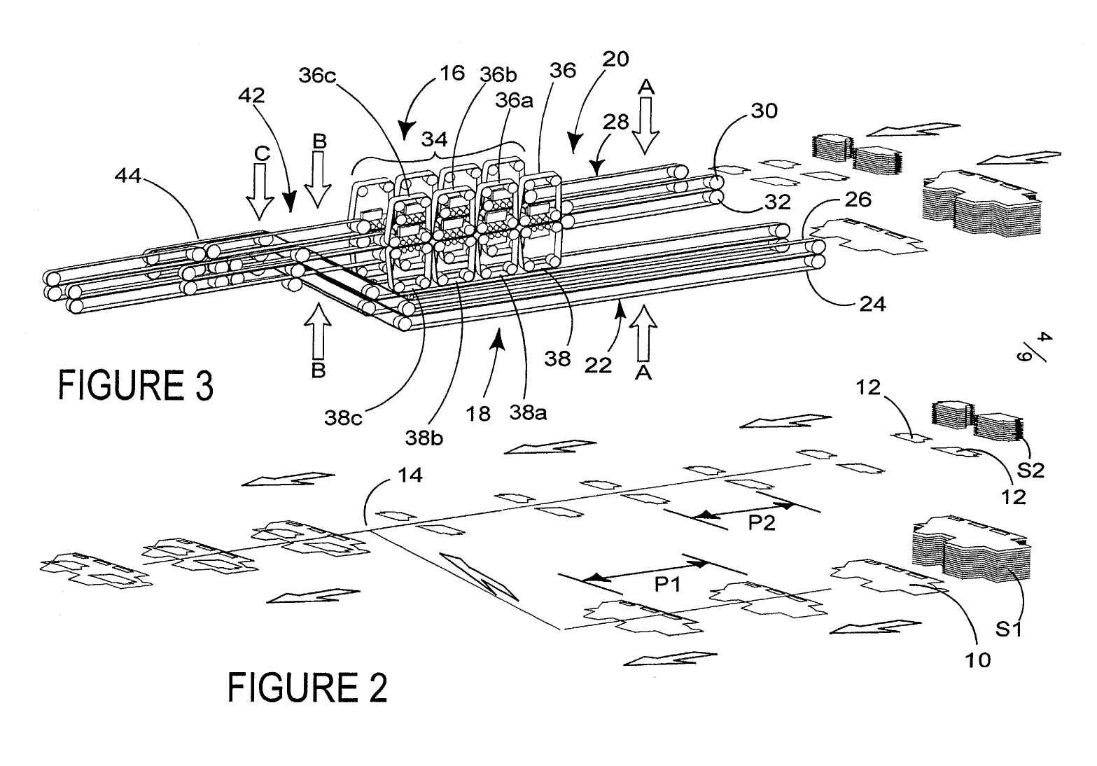

Referring to FIG. 2, there is shown a schematic flow diagram of the blanks 10 and 10 inserts 12. It will be seen that the blanks 10 are continuously fed from a supply S1 with a pitch P1 between adjacent blanks. Likewise, the inserts 12 are fed from a supply S2 thereof with a pitch P2 between adjacent inserts.

In those embodiments where the insert length X, shown in FIG. 1A, differs from the blank 10 length Y, the pitch PI will differ from P2. Therefore, the position and/or speed of the insert 12 will be different to the position and/or speed of the blank 10 in order that the blank 10 and inserts 12 are aligned. Furthermore, apparatus used to convey the articles through a machine will create differences between the individual pitches P1 and P2, for example slippage caused by the frictional engagement between the conveyors and the blanks 10 or inserts 12. Therefore there is a tolerance value between the positions of the blank and the inserts and hence there is likely to be a misalignment in relative position of a pair of inserts 12 to a corresponding blank 10 such that when the inserts 12 and blank 10 converge, the inserts may not be placed in the correct location on the blank. In this embodiment, the expected tolerance will be +or − 25 mm. Therefore, a correction device 34 is used to ensure that each pair of inserts 12 is aligned with a corresponding blank 10 before they reach the convergence point 14.

Turning now to FIG. 3, there is shown a schematic diagram of the apparatus according to a preferred embodiment of the present invention which may operate as a standalone apparatus, or be included as a module in a larger carton forming machine that can be supplied new or fitted to an existing machine on a retro fit basis. The apparatus comprises a first feed stream 18 having at an upstream end thereof a hopper (not shown) in which a plurality of blanks 10 are stacked.

Carton feed apparatus (not shown) is positioned underneath the supply hopper 51 so as to feed the blanks into the apparatus 16. In this embodiment, the carton feed apparatus comprises one or more belts which frictionally engage one face of the blank and feed it into a first conveyor means 22 of the feed stream 18. The conveyor means 22 preferably comprises at least one lower belt 24, and at least one upper belt 26 driven by drive means (not shown) such as one or more servo motors, the belts being positioned so as to ‘clamp’ the blanks therebetween and prevent any unwanted lateral or longitudinal movement during the forward feed. In this embodiment two upper, and two lower belts 24, 26 are provided. In normal operation, carton feed apparatus runs at a lower speed than the first conveyor means 22 and the blanks 10 may be accelerated by intermediate conveyor means (not shown) up to the speed of the first conveyor means 22. In this embodiment, the blanks 10 are, therefore, fed through the apparatus 16 with a spacing therebetween which will vary depending upon the overall speed of carton throughput.

Prior art feed devices, such as a rotary feeder, engage each blank causing a fixed number of blanks to be fed each minute with a fixed pitch therebetween. Rotary type timed feeders, however, suffer from the disadvantage that they have a maximum feed rate of approximately 200 blanks per minute, which obviously limits the overall capacity of the machine. Beneficially, the carton feed apparatus described above, is capable of feeding blanks at a much higher rate, but for the reasons given above, there is, in this embodiment, approximately a 25 mm linear tolerance between the theoretical position of a given blank, and its actual position because the feeder is not timed.

In other embodiments with lower carton throughput requirements for example around 35,000 cartons per hour a timed feeder device can be provided by a flat feeder driven by a servo motor with modified belts for example lugs, or a rotary feeder to feed the carton at a known rate or pitch.

Since the position of each blank 10 is not known to a sufficient degree of accuracy, the actual position must be measured. A suitable measurement device, for example a photo-cell or sensor, detects the presence and position of the blanks. This allows glue to be accurately applied to the blank and the relative position of the inserts 10 to be adjusted such that when the two feed streams converge, each insert 12 may be accurately placed on each blank 10 aligned with the glue which has been applied to each blank 12. In this embodiment, the glue is applied by a known gluer device (not shown) located around position B of FIG. 3. The glue is applied to the blank 10 at cross-hatched positions G in FIG. 1B.

Turning now to the second feed stream 20 for the inserts 12, a similar hopper S2 and carton feed arrangement (not shown) is provided at the upstream end thereof, and again, the inserts 12 are fed from the friction belt with small gaps therebetween. As, in this embodiment, the length X of the inserts 10 is less than the length Y of the blanks 12, the second friction feeder runs at a lower speed than the first for the same feed rates to be achieved. The inserts are then preferably accelerated up to the running speed of a second conveyor means 28 of the second feed stream by intermediate conveyor means (not shown) which is running at substantially the same speed as the first conveyor means 22.

The second conveyor means 28 preferably comprises at least one upper belt 30, and at least one lower belt 32. In this embodiment, two inserts 12 are provided to be fed side by side down the second infeed stream and to be placed on the carton blank 10. However, in alternative classes of embodiment, a single, or more than two inserts may be provided. Again, in this embodiment, the position of each insert 12 has an approximate linear tolerance of about 25 mm relative its theoretical position.

The inserts are then fed downstream on the second conveyor means 28 to the article correction device 34 of the apparatus 16. The correction device comprises one or more sets of upper and lower belts 36, 38. In this embodiment there are four sets of upper and lower belts 36, 36a to c; 38, 38a to c positioned in series which engage the inserts 12 therebetween, and which are capable of accelerating or decelerating the inserts 12 relative to the overall running speed of the machine, thereby advancing or retarding particular inserts 12 relative to a blank 10.

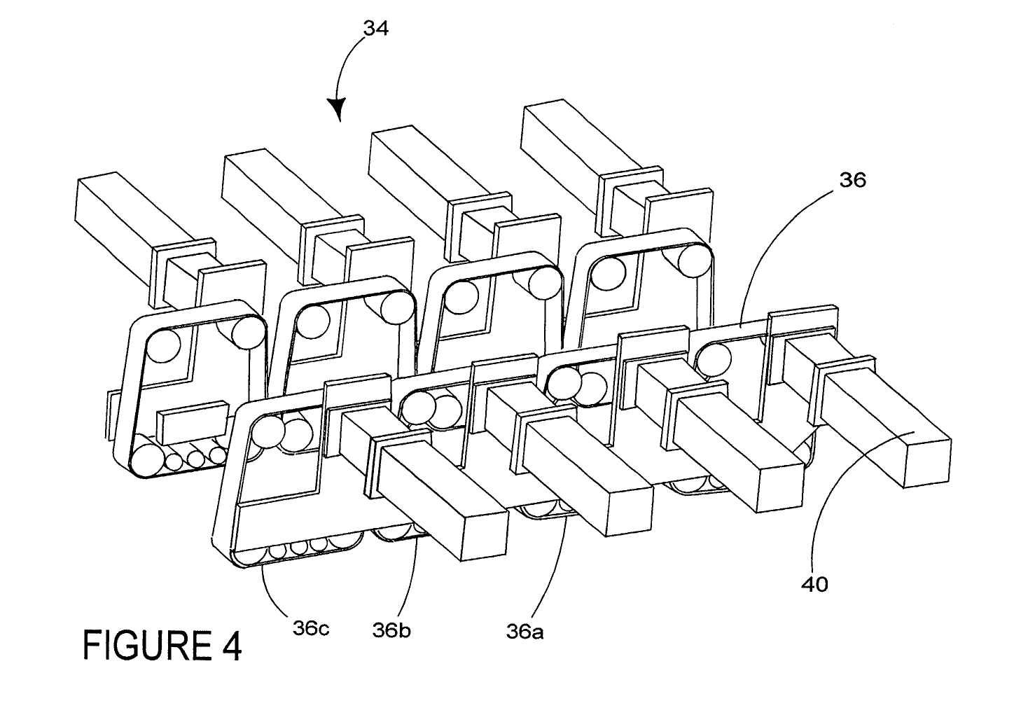

Referring in particular to FIG. 4, each correction belt 36, 38 is driven by independently controlled drive means 40, for example, a servo motor, and at normal running speeds, for example 200 m per minute, is capable of correcting the position of the inserts by approximately 10 mm in either direction. Thus, the insert can be corrected by up to 40 mm with the correction device shown in FIG. 4 comprising four sets of correction belts.

It is envisaged, that if the overall running speed of the apparatus 16 is lowered, the amount of correction capable by each belt 36, 38 may increase so it would be possible to reduce that number of correction belts. To ensure that each insert 10 is fed smoothly from one set of belts to another, for example 36 to 36a; 38 to 38a, both sets of belts must run at the same speed during transfer, the belts 36a, 38a will be caused to either accelerate or decelerate to effect the correction, before reverting to the speed of the machine to match the speed of the next belt 36b, 38b of the correction device 34 for a second transfer to take place. Preferably, a dedicated controller controls the velocity and acceleration vectors of each set of belts, described in more detail below.

Once the position of the inserts 12 has been corrected, the inserts are fed onto a third conveyor means 42 running at the same forward component of velocity as the first conveyor means shown in FIG. 3. The two streams converge at position C, and the inserts are placed in the desired position on the blank preferably to within a tolerance of 1 mm, as illustrated in Figure IC. At least one set of belts 44 preferably compresses the inserts against the blank to allow the glue to set with inserts in the correct position. The blanks 10 with the inserts 12 adhered thereto are then fed towards the outfeed end of the apparatus 16.

In a preferred embodiment an ejection mechanism (not shown) is provided so that if the inserts 12 have not been aligned correctly, the blank 10 and inserts 12 may be ejected from the apparatus 16. A sensor is used to detect the position of the insert and blank, by using a reference point on each. The position is compared against a known position for a correctly aligned blank and insert. If they are not aligned then the controller controls a linear motor (not shown) mounted at the end of the machine. The linear motor runs at a faster speed than the machine to pull a rejected blank off the machine.

The blanks 10 may then be subjected to further operations such as nick breaking, folding, or gluing (not shown) so that the blanks 10 are ready for erection into a carton. The term ‘nick’ is a term used in the art to refer to a connection between two panels.

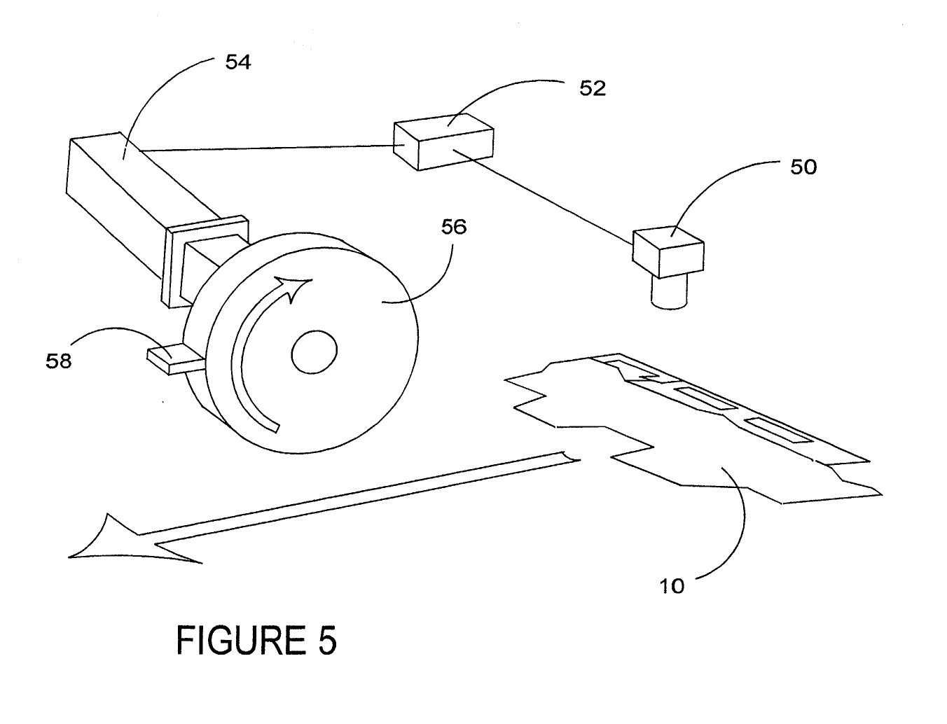

In one class of embodiments, the nick breaking occurs prior to the article adjustment station at position A in FIG. 3. One example of the nick breaking apparatus is shown in FIG. 5. The position of the carton blank 10 (or insert 12) is measured or detected by a suitable detection device 50, for example a photoelectric cell. This information is transmitted to a controller 52, which controls the position, velocity and/or acceleration vectors of a nick-breaking wheel 56. The wheel 56 is driven by suitable drive means 54, for example a servo-motor, controlled by the controller 52.

The controller synchronises the nick breaker element 58 with the blank 10, to cause the breaker element 58 to engage the blank at the desired position to break the nicks. Their desired position can be pre-programmed by the operator or detected by the detection means. The synchronisation is achieved by accelerating or decelerating the wheel 56 relative the blank 10 to cause the element 58 to move forward or backward relatively.

A controller is provided to control the various functions of the apparatus. More particularly, the controller may be a series of dedicated processors that individually control the various elements of the apparatus or may be a control means for the apparatus. Alternatively, the controller may be a programmable control system.

The controller has a central processor, manual input means and a display which indicates useful information to the operator.

The controller controls the positions of the movable components as well as the speed of movement of variable speed components. For example the controller controls the motors which drive the conveyors 22, 28. Furthermore, the controller controls the adjustment of the inserts 12 through programmed and accurate control of each drive means for the belt sets 36, 38 in the correction device 34 for adjusting the inserts in the apparatus. The nick-breaking wheel 56 may be controlled by the controller.

Thus, the positions and speed of the first and second conveyors 22, 28, the correction device 34, the outfeed conveyors 42, 44 as well as the carton feed apparatus can be input manually or a specific pre-written programme can be loaded into the central processor for control of the apparatus. Also, for a controlled changeover of the machine from one carton type or size to another can be the result of a pre-written programme or manual input signal. The apparatus can achieve a changeover with minimum downtime because the adjustments to the machine can be made automatically.

In normal circumstances, the overall speed of the machine is dictated by the required output of finished blanks. Therefore, in this embodiment, the controller controlling the velocity of the blank 10 acts as a “master” to which the relative position of the or each “slave” controllers controlling the velocity of the inserts 12 are adjusted, however, in alternative embodiments, the roles may be reversed. Optionally, the controller controlling the article with the least mass acts as the “slave”, as the inertia is lower, and less powerful driving means is needed for the required acceleration or deceleration to be achieved by the correction belts 34.

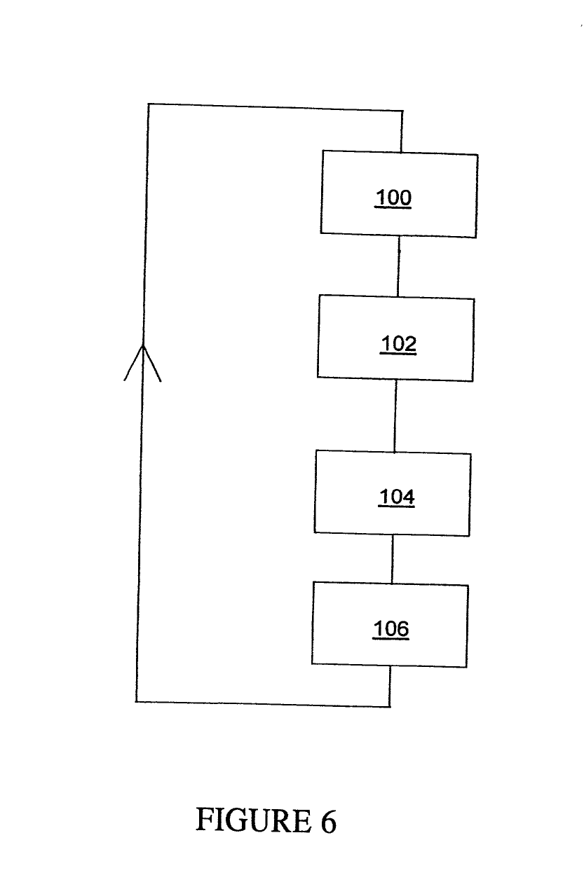

FIG. 6 is a schematic block representation of the device 36, 38 for adjusting the infeed conveyors to approximately synchronise the position and speed of the inserts 12 relative the carton blank 10. The blank feeder is set to feed the desired number of blanks per minute into the first feed stream 18 of the machine by manual input, or in accordance with the pre-programmed controller. The first step (box 100) is to determine the position of each blank 10 in the first feed stream which may be achieved by using a sensor, for example an optical cell, preferably located towards the upstream end of the first conveyor means 22, or by otherwise detecting the velocity of the conveyor 22. In a preferred embodiment, one carton panel is folded out of alignment with the remaining panels by folding means such as a fixed guide (not shown) to provide a reference edge which may be used in conjunction with the sensor.

At the same time, the insert feeder feeds the same number of inserts 12 per minute as blanks 10 which is also controlled by the controller. As, in this embodiment, the length X of the inserts 12 is shorter than the length Y of the blanks 10, the speed of the insert feeder will be lower than the speed of blank feeder in order to feed inserts 12 at the same rate as blanks 10. The controller may also signal the second conveyor means 20 to accelerate, or as the case may be decelerate, the inserts to approximately the same speed as the blanks. To achieve this, the controller measures the position of the inserts (block 102), once accelerated, and the next step (block 104) the controller determines the position of the inserts 12 relative to the blank 10 from the measurements and, if necessary, the controller (block 106) causes the second conveyor means 20 to adjust its speed so that approximate synchronisation between the blank 10 and inserts 12 is achieved 106. This process is repeated for each blank.

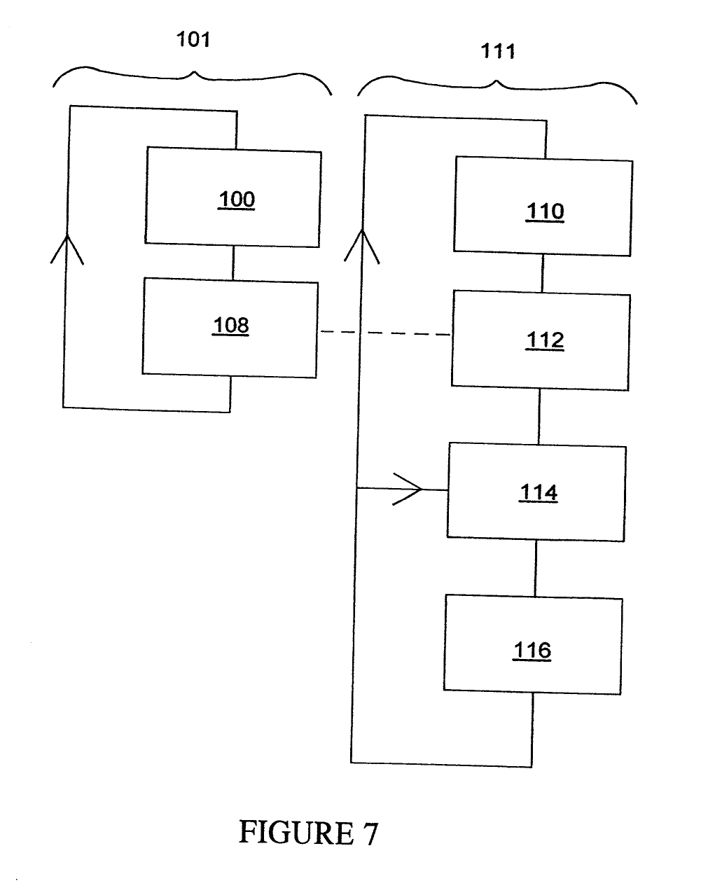

Referring now to FIG. 7, which shows the correcting device process 101 and 111. First, the absolute position of the blank on the conveyor 18 by the sensor (at block 100) during the approximate alignment process is determined. Alternatively, a second sensor may be provided at a position below the correction device. The absolute position of the blank is recorded by the controller (block 108), and when each blank 10 reaches the gluing station sited at position B in FIG. 3, the glue application apparatus is triggered to apply glue to the pre-determined locations on the blanks 10, which can be determined by reference to the absolute position. If rapid bonding is subsequently required between the insert and blank, “hot melt” glue apparatus is used. In some embodiments a combination of “hot melt” and “cold application” glue is used; the hot melt is used to fix the position of the insert or the blank through the machine and the cold glue pneumatically fixes the insert to the blank.

To align the blank and the inserts 111, in FIG. 7, the absolute position of the or each pair of inserts 12 is measured by a second sensor (block 110) located upstream of the first set of correction belts 36, 38 in correction device 34, which information is recorded by the controller. The controller then compares the position of the inserts 12 with the position of the blanks 10, and the blank 10 at the closest position relative to the given pair of inserts 12 is selected (block 112) as the one which will subsequently have the inserts 12 glued thereto.

The next step (block 114) is for the controller to determine the amount of linear adjustment required for alignment to be achieved between the inserts 12 and the selected blank 10 and block 116 represents the output signal to the first set of upper and lower correction belts 36, 38 to achieve as much of the required correction as they are capable of at the given overall running speed i.e. in this embodiment up to 10 mm.

The amount of remaining correction which is required is then measured by a further sensor (not shown) between the first and second correction belts 36,38; 36a, 38a. If alignment has already been achieved, then the remaining correction belts are not required to provide any further correction. If this is not the case, then the controller repeats steps 114 and 116 for the second upper and lower correction belts (36a and 38a) to achieve as much further correction as it can.

The measuring and correction procedure is then repeated for the third and fourth belts until the correct relative alignment is achieved. For example, if the inserts are required to be adjusted forward by 25 mm in the present embodiment the first set 36, 38 would adjust the inserts by 10 mm, the second set 36a, 38a, would likewise adjust the inserts 12 by 10 mm and the third set 36b, 38b would adjust the inserts forward by 5 mm. Alternatively, the first three sets of correction belts 36, 38; 36a, 38a; 36b, 38b may adjust the inserts by the same value with the last set 36c, 38c adjusting the insert by the remaining value. Beneficially, this will reduce wear on the drive means as drive is not primarily restricted to first and second set of belts 36, 38; 36a, 38a.

It should be understood, however, that depending upon the tolerances in the positions of the blank and insert, as well as the running speed of the machine, the number of correction belts may be increased or decreased so that the minimum number necessary are provided. The use of sensors before each correction belt is preferable because it provides an additional feedback to the controller of any error that is introduced by the previous set of correction belts.

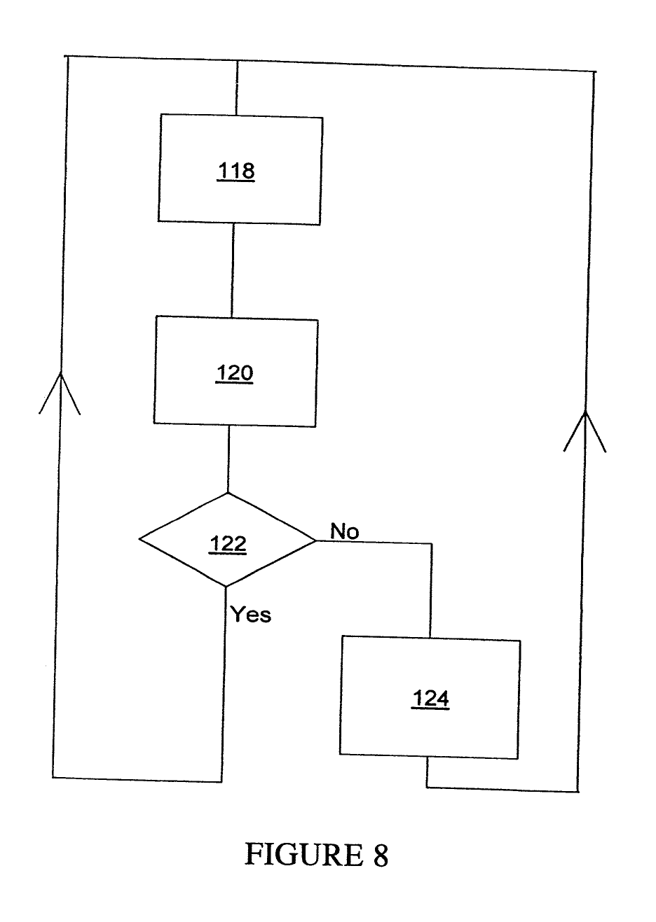

Turning to FIG. 8, once the correction has been completed, in a preferred embodiment, final sensors (118) measure the position of each blank 10 (alternatively, the blank's position maybe retrieved from memory), and the position of the corresponding insert 12 is measured (block 120). The controller (block 122) then determines whether the correct alignment has been achieved. If the alignment is not correct, the controller (block 124) causes an ejection mechanism, described above, to eject the blank and insert from the apparatus. In a preferred embodiment, this is carried after the inserts have been placed on the blank, although in an alternative class of embodiment, separate ejection mechanisms may eject the inserts and blank before they have been glued together.

Assuming the correct alignment has been achieved, the blank and corresponding inserts are fed downstream to the position where the first and second conveyor means 14 converge, and the inserts 12 are placed on the blank 10 and are secured together by the glue or other suitable means. As described above, the third conveyor 44 conveys the carton blank 10 and inserts 12 to the outfeed end of the apparatus to be stacked or onto the next stage of folding and loading the carton.

It should be understood that the present invention can be applied to other applications where the accurate alignment of two or more sheets of paperboard or other sheet material is required. For example, the apparatus may be used to align a handle strap, or a divider panel with a carton blank. The carton blanks used may be of the wraparound or sleeve type, as well as basket carriers. If necessary, alternative means may be used to secure the sheets together, such as mechanical locking means.

It should also be understood that various changes may be made within the scope of the invention. For example, the number of correction belts, and their size may be increased or decreased depending upon the dimensions of the articles to be corrected, alternative drive means such as a hydraulic motors may be employed, and the roles of the inserts and blanks in the overall control of the machine may be reversed.

1. An apparatus for continuously positioning an article, for example a carton blank delivered from one feed stream relative to a second article, for example an insert blank delivered from a second feed stream comprising one or more sensors to detect the respective positions of the first and second articles upstream of where the streams converge, correction means to correct the position of the second article relative to the first article, and a controller to determine the amount of adjustment required and to control the correction means accordingly.

2. The apparatus according to claim 1 wherein the first and second feed streams comprise first and second conveyor means.

3. The apparatus according to claim 1 wherein said first and second articles are fed from continuous friction feeders from a storage hopper.

4. The apparatus according to claim 1 wherein the correction means comprises an article correction belt driven independently of said second conveyor means.

5. The apparatus according to claim 4 wherein the article correction belt comprises upper and lower belts arranged so as to hold the second article therebetween.

6. The apparatus according to claim 4 wherein the article correction belt is driven by a servo-motor.

7. The apparatus according to claim 4 wherein a plurality of article correction belts are provided in series.

8. The apparatus according to claim 4 wherein the correction belt feeds onto a third conveyor means operating at the same speed as the first conveyor means.

9. The apparatus according to claim 8 wherein the controller determines the position of a second article, selects a first article in closest relative alignment thereto, and adjusts the speed of the correction means such that when the second article is engaged by a third conveyor means it is substantially in synchronism with the first article.

10. An apparatus for breaking the nicks of an article, for example a carton blank on a conveyor comprising nick breaking means, one or more sensors to detect the position of the article on the conveyor, characterised in that alignment means is provided to align the nick breaking means with respect to the nicks of an article being conveyed, and in that there further comprises a controller to determine the amount of adjustment required and to control the alignment means.

11. An apparatus for continuously positioning an article, for example a carton blank delivered from one feed stream relative to a second article, for example an insert blank delivered from a second feed stream comprising one or more sensors to detect the respective positions of the first and second articles upstream of where the streams converge, correction means to correct the position of the second article relative to the first article, a controller to determine the amount of adjustment required and to control the correction means accordingly, and including apparatus for breaking the nicks of an article, for example a carton blank on a conveyor comprising nick breaking means, one or more sensors to detect the position of the article on the conveyor, characterised in that alignment means is provided to align the nick breaking means with respect to the nicks of an article being conveyed, and in that there further comprises a controller to determine the amount of adjustment required and to control the alignment means.

12. A controller for apparatus for continuously positioning a first article delivered from a first feed stream relative to a second article delivered from a second feed stream, wherein the controller processes information supplied from a first sensor which detects the position of a continuous stream of the first articles, and a second sensor which detects the position of the second articles, selects the first article in closest relative alignment with the second article, determines the correction necessary to bring the first and second articles into the desired relative positions, and outputs an appropriate signal to a correction means for the necessary correction to be achieved.

13. A controller according to claim 12 wherein the controller further controls a mechanism for ejecting misaligned first and second articles.

14. The controller as claimed in claim 12 wherein the controller controls apparatus for breaking the nicks of the first and/or second articles comprising processing information of the position of the first and/or second articles, determine the position of nick breaking means relative said article and adjusting the nick breaking means to cause it to be aligned with said article.

15. A control means for an apparatus for positioning a first article with respect to a second article, the control means comprising a central controller, a manual input means, and separate means controlled by said central controller for individually controlling the or each set of article correction belts.

16. The control means as claimed in claim 15, further comprising a sensor and a processor for determining the position of the second article relative the first article.

17. The control means as claimed in claim 15, wherein a first conveyor means for transporting said first article is controlled by the central controller.

18. The control means as claimed in claim 15, wherein speeds of the feed mechanisms for said first and second articles are controlled be the central controller.

19. The control means as claimed in claim 15, wherein an instruction to changeover from one article type to another is read from a pre-entered control program.

20. The control means as claimed in claim 19, wherein the speed of supply of articles is alterable as required depending on the size or type of the articles in each of said hoppers.

21. The control means as claimed in claim 15, wherein the relative positions and state of motion of each of the movable components is sensed using individual sensors and transmitted to the central controller.

22. A method of continuously positioning an article delivered from a first feed stream relative to a second article delivered from a second feed stream comprising the steps of determining the position and speed of continuous flow of first articles as they progress downstream; selecting one of the first articles in closest relative alignment to the second article, adjusting the linear position of the second article relative to the selected first article, and feeding the first and second articles downstream to a position where they converge in alignment.

23. A method according to claim 22 wherein a belt driven by a servo-motor adjusts the linear position of the second article.
